(19) United States
(12) Patent Application Publication
(10) Pub. No.: US 2016/0101448 A1
(43) Pub. Date: Apr. 14, 2016

(54) ATTACHABLE TEETH FOR CLEANING HAND TOOLS

(71) Applicants: Nancy D. Kelley, Yellow Springs, OH (US); Malcolm E. Kelley, Yellow Springs, OH (US)

(72) Inventors: Nancy D. Kelley, Yellow Springs, OH (US); Malcolm E. Kelley, Yellow Springs, OH (US)

(21) Appl. No.: 14/512,507

(22) Filed: Oct. 13, 2014

(51) Int. Cl. B08B 13/00; B08B 1/00

(52) U.S. Cl. CPC B08B 13/00; B08B 1/005

(57) ABSTRACT

A device for cleaning hand tools comprises a substrate, teeth protruding from the substrate, and an attaching/clipping mechanism that can attach/clip the device to a corresponding apparatus.

### BACKGROUND

Various aspects of the present invention relate generally hand tools and more specifically to cleaning hand tools.

People use hand tools for cleaning, gardening, etc.

### BRIEF SUMMARY

According to aspects of the present invention, a device for cleaning hand tools comprises a substrate, teeth protruding from the substrate, and an attaching or clipping mechanism that can clip or otherwise attach the device to a corresponding apparatus.

### BRIEF DESCRIPTION OF THE SEVERAL VIEWS OF THE DRAWINGS

FIG. 1 is a drawing illustrating a device with teeth with a clipping mechanism to attach the teeth to an apparatus such as a container, according to various aspects of the present invention.

FIG. 2 is a drawing illustrating a device with teeth with its shape optimized for attaching to an apparatus with a curved top such as a muck bucket, using bolts, screws, and/or adhesive for attaching the device, according to various aspects of the present invention.

### DETAILED DESCRIPTION

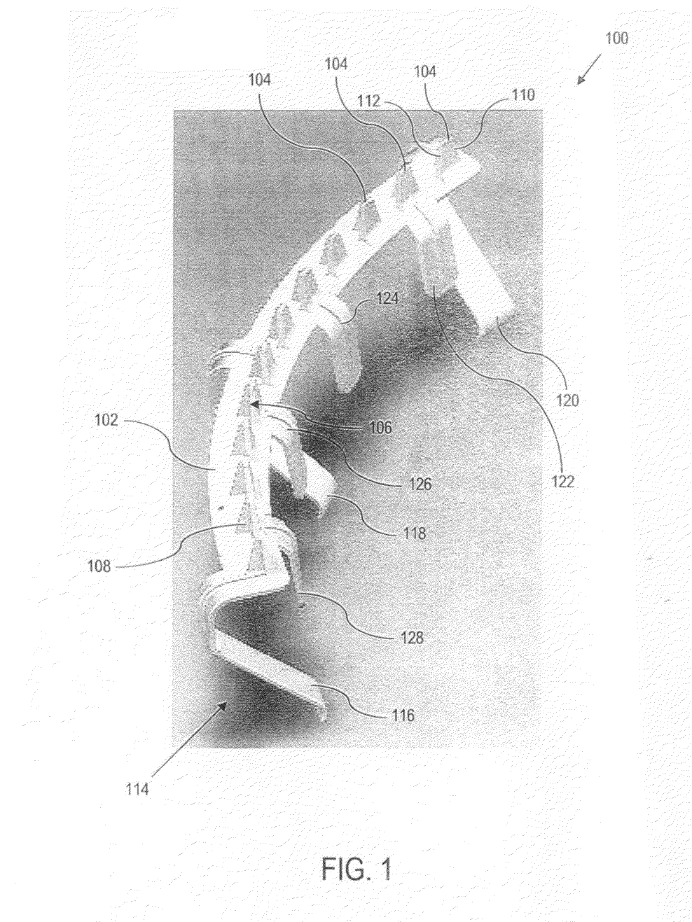

FIG. 1 illustrates a device 100 including a substrate 102 with a series of teeth 104 protruding from the substrate 102. As shown, the teeth 104 have a cleaning portion 106 that is flat and a strengthening portion 108 extending from the cleaning portion 106, reinforcing the teeth 104 to prevent the teeth 104 from breaking during use. As shown, the strengthening portion 108 slopes (e.g., wider near a bottom of the slope) and is generally perpendicular to the cleaning portion 106. However, the strengthening portion 108 may be of any shape (e.g., rounded, a thicker extension of the cleaning portion, having no slope, integrated with the cleaning portion, etc.). Moreover, as shown the cleaning portion 106 of the teeth 104 has generally sloping sides 110, 112 that slope toward a middle of an individual tooth 104. Thus, an individual tooth 104 may be triangular-shaped or generally trapezoidal in shape. However, the teeth are not required to be sloped in such a way.

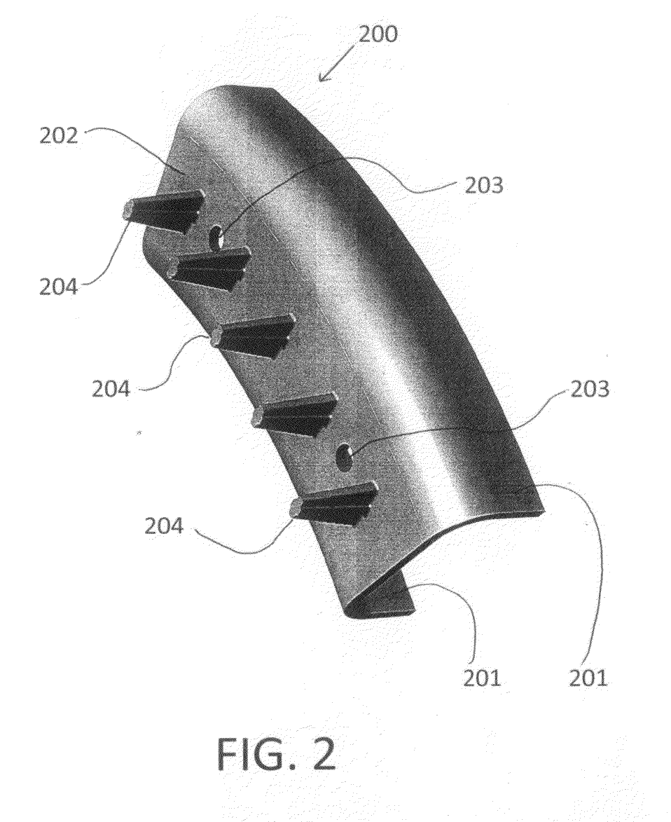

FIG. 2 illustrates a device 200 with identical substrate 202 and identical teeth 204 to FIG. 1 but which uses bolts, screws, and/or adhesive to attach the device to a corresponding apparatus such as a muck bucket. Holes 203 through the substrate 202 would be used for attaching bolts and/or screws. FIG. 2 shows a device with two sides 201 that curve down to wrap around a corresponding apparatus such as a muck bucket with a specific width of its top edge. However, the FIG. 2 device could also have only one side 201 curve down to fit on a corresponding apparatus that has wider or narrower widths of the top edge. The FIG. 2 device could also be flat on the bottom (no curve down 201 part) to fit on a corresponding apparatus with a flat or curved surface which is not a top edge, and in this case the substrate may be curved such that the device matches the curvature of the surface of the corresponding apparatus.

Further, the FIG. 1 device 100 includes a clipping mechanism 114 that allows the device to clip to a corresponding apparatus. For example, the device 100 may be attached to a bucket. In such a case, the substrate 102 may be curved such that the device 100 matches the contours of the bucket. However, if the device is for an apparatus with a straight edge (e.g., wheelbarrow, trough, etc.), then the substrate may be straight. On the other hand, the substrate 102 does not need to match the contours of the apparatus. Instead, the clipping mechanism 114 may be matched to the contours, while the substrate 102 is not.

As shown, the clipping mechanism 114 includes three springs 116, 118, 120 and four clips 122, 124, 126, 128. The springs attach 116, 118, 120 the device 100 to one side of the apparatus, while the clips 122, 124, 126, 128 attach the device to another side of the apparatus. However, other clipping mechanisms may be used. For example, more or less springs may be used, more or less clips may be used, the clips and springs may be intermingled on one side of the device. Bolts, screws, and/or adhesive could also be used instead of or in addition to the clips and springs to attach the device when permanent attachment to one item (muck bucket, etc.) is desired.

When the device 100 is attached to an apparatus, a user may clean a hand tool by scraping the hand tool against the teeth 104. For example, if the device is attached to a muck bucket, the user may clean a manure fork by scraping the tines of the manure fork along the teeth 104 of the device 100. The sloped sides 110, 112 of the teeth 104 allow manure forks of different spacing, different tine widths, or both to be cleaned with the teeth 104. When the muck bucket is instead used for collecting weeds or leaves from the yard or garden, the teeth allow leaves to be cleaned off of leaf rakes.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A device comprising:
a substrate;
teeth protruding from the substrate; and
an attaching/clipping mechanism to affix the device to a corresponding apparatus.

2. The device of claim 1, wherein the teeth include:
a flat, cleaning portion; and
a strengthening portion.

3. The device of claim 2, wherein the strengthening portion further includes a sloping portion generally perpendicular to the cleaning portion of the teeth.

4. The device of claim 2, wherein the cleaning portion is generally sloped on the sides.

5. The device of claim 4, wherein the cleaning portion is generally triangular.

6. The device of claim 4, wherein the cleaning portion is generally trapezoidal.

7. The device of claim 1, wherein the substrate is generally curved.
